(19) United States
(12) Patent Application Publication
(10) Pub. No.: US 2003/0063458 A1
(43) Pub. Date: Apr. 3, 2003

(54) Lighting luminaire using only one light source and forming method thereof

(76) Inventors: Hui-Liang Chien, Taichung (TW); Chi-Feng Cheng, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/968,900

(22) Filed: Oct. 3, 2001

(51) Int. Cl. F21V 8/00; F21V 7/04; F21K 7/00

(52) U.S. Cl. 362/31; 362/561; 362/330; 362/327

(57) ABSTRACT

A lighting luminaire using only one LCD element as a light source comprises a light conducting frame; a unit LCD element disposed at a position near one corner of the light conducting frame, to function as a point light source and a reflector plate provided at the rear surface of the light conducting frame. A specially designed pattern is formed on the rear surface of the light conducting frame according to an area distribution function. Moreover, several ramps are formed along the inner edge of the light conducting frame so as to further improve uniform distribution of output light. In the invention, a forming method of this lighting luminaire is also disclosed.

### BACKGROUND OF THE INVENTION

1. Field of the Invention

The present invention relates to a lighting luminaire using only one LCD element as a light source, and forming method thereof, which is effective in obtaining uniform light distribution with low power consumption.

2. Description of the Prior Art

There are a plurality of LCD elements contained in a conventional LCD luminaire. Those LCD elements to be used as a light source are disposed around the inner edges of the lighting luminaire to emit light rays, while a patterned plate is provided at the inner surface of the luminaire to function as a reflector. As the light source is turned on, the emitted light rays are reflected by the patterned reflector and outputted to desired directions according to the pattern on the reflector plate thereof.

As the nature of a LCD element is a point light source whose light intensity is strongest in the forwards direction, but there are almost no light rays emitted to other directions. If there is no properly designed lighting luminaire to be associated with a LCD light source disposed at the center position of the lighting luminaire, it is impossible to obtain a desired uniform light distribution from a planar light source by using only one LCD element. If a plurality of LCD elements are employed to obtain uniform lighting effect from a planar light source, there is other problems of high power consumption and electromagnetic interference.

### SUMMARY OF THE INVENTION

In order to solve the above described problems, the present inventor carried out theoretical studies and simulating experience. Based on these studies and researches, the present inventor came to propose the present invention.

It is an object of the present invention to provide a lighting luminaire using only one LCD element as a light source instead of using four LCD elements or more in a conventional practice so as to save power consumption and eliminate electromagnetic interference.

It is another object of the present invention to provide a lighting luminaire using only one LCD element as a light source wherein ununiformity of light distribution of the lighting luminaire is further improved by forming several ramps along the inner edge of the lighting luminaire.

It is one more object of the present invention to provide design method of this lighting luminaire.

These and other objects of the present invention can be achieved by providing a lighting luminaire comprising a light conducting frame; a unit LCD element disposed at a position near one corner of the light conducting frame, to function as a point light source; and a reflector plate provided at the rear surface of the light conducting frame. A specially designed pattern is formed on the rear surface of the light conducting frame according to an area distribution function by laser processing or plastic ejection process. Moreover, several ramps are formed along the inner edge of the light conducting frame so as to further improve uniform distribution of output light.

### BRIEF DESCRIPTION OF THE DRAWING

For fuller understanding of the nature and objects of the invention, reference should be made to the following detailed description taken in conjunction with the accompanying drawings.

FIG. 1 is a front view of a lighting luminaire using only one LCD element in a first embodiment of the present invention;

FIG. 2 is a side view of FIG. 1;

FIG. 3 is a rear view of FIG. 1;

FIG. 4 is a drawing showing the state of light tracks of FIG. 1;

FIG. 5 is a front view of a lighting luminaire using only one LCD element in a second embodiment of the present invention.

### DETAILED DESCRIPTION OF THE PREFERRED EMBODIMENTS

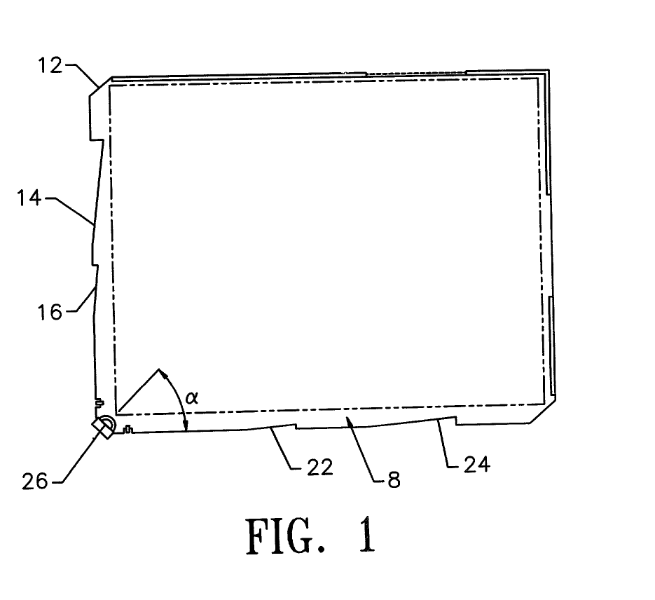

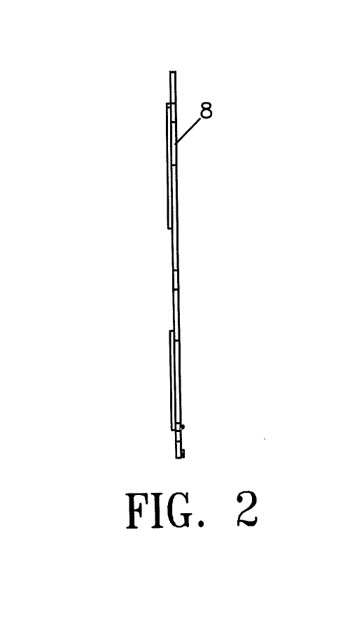

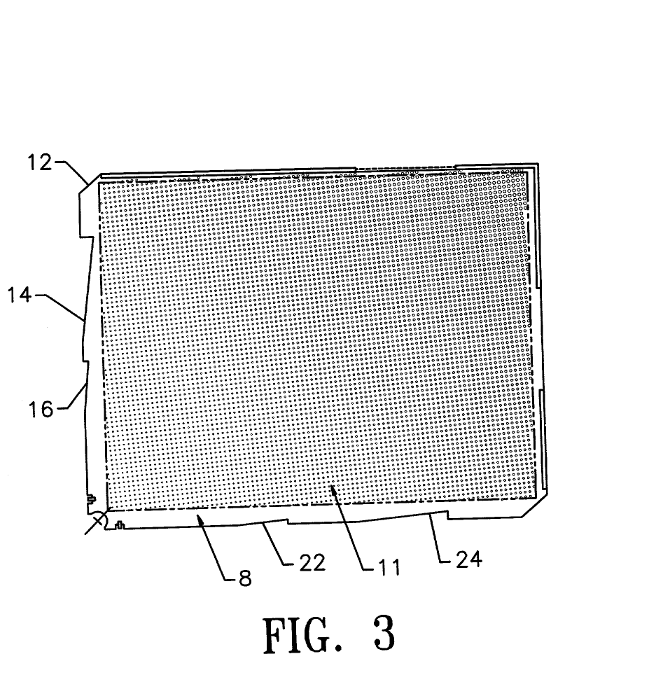

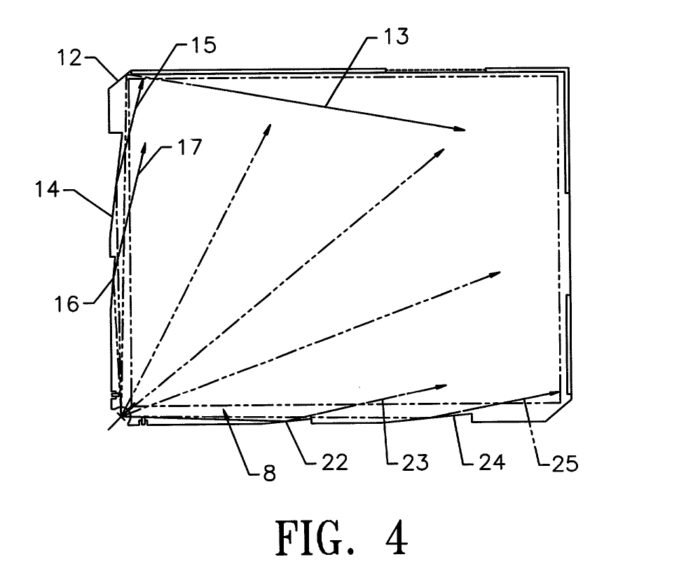

Referring to FIGS. 1 through 4 simultaneously, the lighting luminaire of the present invention comprises a light conducting frame 8; a unit LCD element 26 disposed at a position near one corner of the light conducting frame 8, to function as a point light source; and a reflector plate (not shown) provided at the rear surface of the light conducting frame 8. The emitted light from the point light source. i.e. LCD element 26 is conducted into the lighting luminaire along an extended structure of the light conducting frame 8 in diffused state before being outputted. A specially designed pattern 11 is formed on the rear surface of the light conducting frame 8 in accordance with an area distribution function by laser processing, or plastic ejection process, or printing process, or extrusion process, or mechanical or yellow light processing (see FIG. 3). The form of mesh distribution in this pattern 11 is different from that according to conventional techniques in the way that variation of mesh density of the pattern 11 is in a defined relation with a main axis along a line forming an angle α with the horizontal line (x-axis) assuming point light source 26 is located at the origin of coordinate. The value of a is generally 20°˜70°. Several ramps 12, 14, 16, 22, 24 are formed along the inner edge of the light conducting frame 8 so as to capture and reflect the biased light rays into effective directions 13, 15, 17, 23, 25, etc. thereby eliminating unlighted dark space as shown in FIGS. 3 and 4. In this version the lighting luminaire of the present invention is able to become a uniform planar light source. The tilted angle of ramps is variable from 5° to 60° depending on the contour and dimension of the lighting luminaire.

In an embodiment of the present invention shown in FIG. 1, the meshes formed by sand spraying gradually from sparse and dense away from the point light source are finer than being formed by etching such that the fine meshes can serve to prevent the light from random reflection during proceeding to the light conducting frame 8 and reflecting from the reflector plate at the rear surface of the light conducting frame 8 to the front direction so as to improve light intensity and uniformity (see FIG. 3)

As it is illustrated above, the variation of mesh density of the pattern 11 is in a defined relation with a main axis along a line forming an angle of α (20°˜70°) with the X axis. The mathematical analysis is shown below:

A1(x)=a1(y)*e^{b1(y)*x} (1)

A2(x)=a2(y)*e^{b2(y)*x} (2)

Wherein An(x) represents ratio of area distribution at the center portion of the pattern to the entire vision area (n=1, or 2), X represents the distance from the light source 26 to the above center-portion.

L represents the distance from the light source 26 to the opposite corner of the light conducting frame 8, an(y) and bn(y) are both the functions of L, wherein,

b(L)=D(L)*e^{-0.0179*L} (3)

b1(y)=b(L)*e^{(0.02*y)} (4)

b2(y)=b(L)*e^{(-0.06*y)} (5)

[dA(x)/dx]*L=0.5˜0.7 (6)

an(y)=A1(L)/e^{(bn(y)*L)} (7)

An(L)=A(L)*b(L)/bn(y) (8)

Wherein D(L) is a function related to the depth of center point of the pattern and L, for a common 1 mm thick plate, the average depth of a mesh is 20˜30 μm, them D(L) equals 0.1. L is defined as the distance from a point near the light source to the most distal point in the vision area along the main axis forming a specified angle with the horizontal line (X axis).

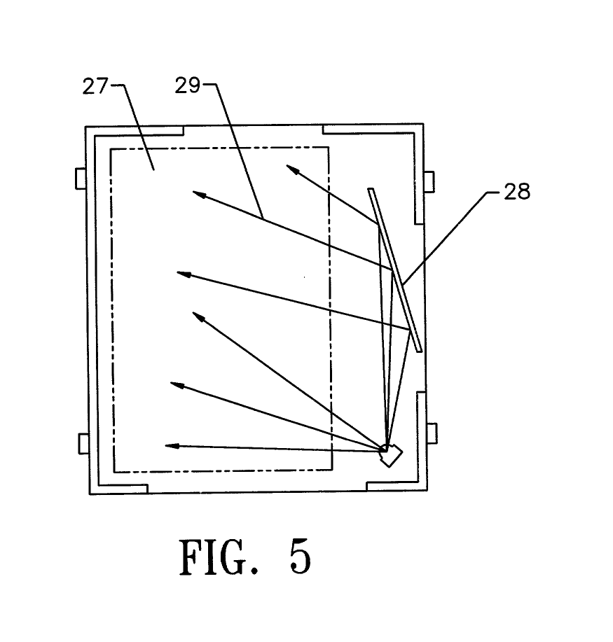

Here, in another embodiment of the present invention shown in FIG. 5, an empty cavity 28 is formed in the light conducting frame 8 to reflect the light 29 which is excursing away from the vision area 27 such that the excursed light 29 is effectively captured into the vision area 27 thereby increasing the light intensity and improving light uniformity thereof.

As for the steps of forming method of the present invention comprising the steps:

a) disposing a point light source 26 near the corner of a light conducting frame 8;

b) forming a specially designed pattern 11 on the year surface of the light conducting frame 8 according to an area distribution function; and

c) forming several ramps 12, 14, 16, 22, 24 along the inner edge of the light conducting frame 8 so as to capture and reflect the stray light trays 13, 15, 17, 23, 25 into desired directions.

It emerges from the description of the above embodiments that the invention has several noteworthy advantages, in particular:

1. Only one LCD element is used as a point light source instead of using a plurality of LCD elements as in a conventional practice so as to save power consumption and eliminate electromagnetic interference.

2. Several ramps are formed along the inner edge of the light conducting frame to capture and reflect stray light rays into effective directions thereby further improving the lighting efficiency and uniformity.

3. A lighting luminaire with specially designed reflector patterns caused it able to use a point light source to serve an equivalent effectiveness of a planar light source with a simple structure and a minimum cost.

Those who are skilled in the art will readily perceive how to modify the invention. Therefore the appended claims are to be construed to cover all equivalent structures which fall within the true scope and spirit of the invention.

What is claimed is:

1. A lighting luminaire using only one LCD element as a light source comprising:
a light conducting frame;
a unit LCD element disposed at a position near one corner of said light conducting frame, to function as a point light source; and
a reflector plate provided at the rear surface of said light conducting frame,
a specially designed pattern is formed on the rear surface of said light conducting frame according to an area distribution function by laser processing or plastic ejection processing, and several ramps are formed along the inner edge of said light conducting frame so as to further improve uniform distribution of output light.

2. The lighting luminaire of claim 1, wherein said point light source is disposed at a position near one corner of said light conducting frame.

3. The lighting luminaire of claim 1, wherein the emitted light from said point light source is conducted into said lighting luminaire along an extended structure of said light conducting frame in diffused state before being outputted.

4. The lighting luminaire of claim 1 wherein said ramps formed along the inner edge of said light conducting frame are with a tilted angle between 5° and 60° used for capturing and reflecting biased light rays into effective directions thereby eliminating unlighted dark space.

5. The lighting luminaire of claim 1, wherein an empty cavity is formed in said light conducting frame to reflect the light which is excursing away from the vision area such that the excursed light is effectively conducted into the vision area.

6. A forming method of a lighting luminaire using only one LCD element as a light source comprising the steps:
a) disposing a point light source near the corner of a light conducting frame;
b) forming a specially designed pattern on the rear surface of said light conducting frame according to an area distribution function; and
c) forming several ramps along the inner edge of said light conducting frame so as to capture and reflect the stray light rays into effective directions.

7. The forming method of claim 6, wherein the variation of mesh density of said pattern is in a defined relation with a main axis along a line forming an angle of a (20°˜70°) with the X axis assuming:
A1(x)=a1(y)*e^{b1(y)*x} (1)
A2(x)=a2(y)*e^{b2(y)*x} (2)
wherein An(X) represents ratio of occupied area at the center portion of said pattern to the entire vision area (n=1, or 2), X represents the distance from said light source to the above center portion, L represents the distance from said light source to the opposite corner of said light conducting frame, an(y) and bn(Y) are both the functions of L, wherein
b(L)=D(L)*e^{-0.0179*L} (3)
b1(y)=b(L)*e^{(-0.02*y)} (4)
b2(y)=b(L)*e^{(-0.06*y)} (5)
[dA(x)/dx]*L=0.5˜0.7 (6)
an(y)A1(L)/e^{(bn(y)*L)} (7)
An(L)=A(L)*b(L)/bn(y) (8)
wherein DL is a function related to the depth of center point of said pattern and L, for a common 1 mm thick plate, the average depth of a mesh is 20˜30 μm, then D(L) equals 0.1, L is defined as the distance from a point near the light source to the most distal point in the vision area along the main axis forming a specified angle with the horizontal line (X-axis).
